(19) United States
(12) Patent Application Publication
(10) Pub. No.: US 2008/0197611 A1
(43) Pub. Date: Aug. 21, 2008

(54) Curtain airbag and curtain airbag apparatus

(75) Inventor: Hisashi Kabata, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 12/003,433

(22) Filed: Dec. 26, 2007

(30) Foreign Application Priority Data
Feb. 20, 2007 (JP) 2007-039640

(51) Int. Cl. B60R 21/231; B60R 21/264

(52) U.S. Cl. 280/730.2; 280/728.1; 280/741

(57) ABSTRACT

A curtain airbag includes a non-expanding portion located halfway along the curtain airbag in a front-and-back direction, a front expanding chamber provided at a vehicle front side of the non-expanding portion, a rear expanding chamber provided at a vehicle back side of the non-expanding portion, an upper expanding chamber provided at an upper side of the non-expanding portion, a lower expanding chamber provided at a lower side of the non-expanding portion, and a vertical expanding chamber connected to a halfway portion of the lower expanding chamber in a front-and-back direction. The vertical expanding chamber allows the gas to flow therethrough, and extends upward. The vertical expanding chamber is connected only to the lower expanding chamber to allow the gas to flow therethrough.

### BACKGROUND THE INVENTION AND RELATED ART STATEMENT

The present invention relates to a curtain airbag (curtain-shaped airbag) extending downward along a side surface in a vehicle interior, and more specifically, it relates to a curtain airbag in which a part of a halfway portion in the front-to-back direction is configured to be a non-expanding portion and a periphery of the non-expanding portion is configured to be an expanding chamber. Further, the present invention relates to a curtain airbag apparatus provided with the curtain airbag.

In an automobile provided with a curtain airbag apparatus, when the automobile encounters a side collision or the like and is overturned, a curtain airbag is expanded toward a lower side of a vehicle body along a side surface of a vehicle interior (for example, a door or a pillar), and protects a head portion of an occupant and holds the occupant in the vehicle interior.

An output power of a gas-generator can be reduced by forming a portion in the curtain airbag, which does not face the occupant, or the like, to be a non-expanding portion.

In Japanese Unexamined Patent Application Publication No. 2003-104162 (Patent Document 1), a curtain airbag, in which expanding portions are disposed at a front side and a backside of the non-expanding portion, respectively, and transversal expanding portions respectively extending in a front-to-back direction are disposed at an upper side and a lower side of the non-expanding portion, is described. The upper side transversal expanding portion allows upper portions of the front side expanding portion and the backside expanding portion to communicate with each other. Further, the lower side transversal expanding portion allows lower portions of the front side expanding portion and the backside expanding portion to communicate with each other.

This curtain airbag is disposed along a roof side rail of the vehicle in a folded back condition in a manner so that a vertical width is reduced, and the top edge thereof is fixed onto the roof side rail.

In Patent Document 1, a gas-flowing-in portion is disposed in the vicinity of the middle portion in the front-and-back direction of the upper edge of the curtain airbag. Gas is supplied from the gas-flowing-in portion into the curtain airbag, and the gas flows into each of the expanding portions, and each of the expanding portions is expanded. Therefore, the curtain airbag is extended downward along the side surface of the vehicle interior.

Currently, a tension force is added in a manner so as to stretch the non-expanding portion in the front-and-back direction from the respectively expanded front side expanding portion and the backside expanding portion to the non-expanding portion. Therefore, the non-expanding portion becomes tense.

Currently, since the non-expanding portion is stretched in the front-and-back direction, a tension force tending to shrink in the up and down direction is generated in the non-expanding portion. Therefore, the lower side expanding portion is stretched upward by the tension force. As a result, the lower side expanding portion is sometimes bent upward and formed in a substantially dog-leg shape in a gooseneck manner.

In FIG. 1 in Japanese Unexamined Patent Application Publication No. 2006-224749 (Patent Document 2), a curtain airbag, in which expanding portion cells are respectively disposed at front and back sides of a non-expanding portion, and at upper and lower sides of the non-expanding portion, first and second gas-introducing paths respectively extending in a front-and-back direction are provided, and in which a pair of gas-introducing path that passes transversely across the non-expanding portion on a slant is provided, is described.

The first gas-introducing path at the upper side of the non-expanding portion allows upper portions of the expanding portion cell at the front side of the non-expanding portion (front side expanding portion cell) and the expanding portion cell at the backside thereof (backside expanding portion cell) to communicate with each other. The second gas-introducing path at the lower side of the non-expanding portion allows lower portions of the front side expanding portion cell and the backside expanding portion cell to communicate with each other.

A pair of gas-pressure introducing paths is disposed so as to intersect in an X-shaped manner to each other.

In one side of the gas-pressure introducing path, an upper end thereof is connected to the vicinity of the intersecting corner portion of the backside expanding portion cell and a back end of the first gas-introducing path allowing gas to flow therethrough, and a lower end thereof is connected to the vicinity of a front end of the second gas-introducing path, allowing the gas to flow therethrough. Further, in the other side of the gas-pressure introducing path, an upper end thereof is connected to the vicinity of the intersecting corner portion of the front side expanding portion cell and a front end of the first gas-introducing path, allowing the gas to flow therethrough, and a lower end thereof is connected to the vicinity of the intersecting corner portion of the backside expanding portion cell and a back end of the second gas-introducing path, allowing the gas to flow therethrough. Each of the gas-introducing paths mutually allows the gas to flow therethrough at the intersecting portion thereof.

In a case that the curtain airbag described in Patent Document 2 is expanded and extended, the backside expanding portion cell, the first gas-introducing path, the front side expanding portion cell, and the second gas-introducing path are expanded while surrounding the non-expanding portion, and a pair of the gas-pressure introducing paths is expanded while passing in the X-shaped manner transversely across the non-expanding portion. Hence, the backside expanding portion cell, the first gas-introducing path, the front side expanding portion cell, and the second gas-introducing path, and a pair of the gas-pressure introducing paths respectively have a structure of being connected to a truss-shaped manner. Therefore, rigidity of the second gas-introducing path at the lower side of the non-expanding portion increases and this prevents the second gas-introducing path from being bent upward.

In the curtain airbag described in the aforementioned Patent Document 2, the upper end side of one side of the gas-pressure introducing path is connected to the vicinity of the intersecting corner portion of the backside expanding portion cell and the first gas-introducing path, allowing the gas to flow therethrough. Hence, in the case that the gas is supplied from a gas-introducing inlet disposed at a back end side of the upper edge of the curtain airbag into the curtain airbag, the gas flows from the gas-introducing inlet into the first gas-introducing path, the backside expanding portion cell, and one side of the gas-pressure introducing path, respectively.

Accordingly, flowing amount of the gas flowing into the backside expanding portion cell and the flowing amount of the gas flowing into the front side expanding portion cell are reduced to the extent of the gas flowing into the one side of the gas-pressure introducing path. This results in a delay of an expanding operation of the backside expanding portion cell and the front side expanding portion cell.

In order to rapidly expand the front side expanding portion cell and the backside expanding portion cell at a time when the curtain airbag described in Patent Document 2 is extended, it is possible to use a high-power gas-generator. However, if the high-power gas-generator is used, the curtain airbag apparatus needs to be large and the weight thereof is also increased. Further, a construction cost of the curtain airbag apparatus becomes high.

It is an object of the present invention to provide a curtain airbag capable of preventing and suppressing an expanding chamber at a lower side of a non-expanding portion from being bent, and capable of rapidly expanding each of the expanding chambers at a front side and a backside of the non-expanding portion without using a high-power gas generator, and to provide a curtain airbag apparatus provided with the curtain airbag.

Further objects and advantages of the invention will be apparent from the following description of the invention.

### SUMMARY OF THE INVENTION

In a curtain airbag according to the first aspect of the present invention, a curtain airbag extends downward along a side surface of a vehicle interior. In the curtain airbag according to the first aspect, a part of the curtain airbag located halfway along the curtain airbag in a front-and-back direction serves as a non-expanding portion. A front expanding chamber is provided at a vehicle-front side of the non-expanding portion, a rear expanding chamber is provided at a vehicle-back side of the non-expanding portion, and an upper expanding chamber is provided at an upper side of the non-expanding portion. A lower expanding chamber is provided at a lower side of the non-expanding portion, the upper expanding chamber and the lower expanding chamber are respectively connected to the front expanding chamber and the rear expanding chamber allowing gas to flow therethrough. A vertical expanding chamber connected to a halfway portion of the lower expanding chamber in a front-and-back direction allowing the gas to flow therethrough and extending upward is provided, and the vertical expanding chamber is connected only to the lower expanding chamber to allow the gas to flow therethrough.

In the curtain airbag according to the second aspect of the invention, the curtain airbag according to the first aspect has a distance between an upper end of the vertical expanding chamber and the upper expanding chamber of 30 mm or less.

A curtain airbag apparatus according to the third aspect of the present invention includes the curtain airbag according to the first aspect and a gas generator for expanding the curtain airbag by supplying gas into the curtain airbag.

In the curtain airbag according to the present invention, a vertical expanding chamber connected to a halfway portion of the lower expanding chamber, which is disposed at a lower side of a non-expanding portion, in a front-and-back direction allowing the gas to flow therethrough and extending upward is provided. Hence, when the curtain airbag is expanded and extended, the vertical expanding chamber is expanded from the halfway portion of the lower expanding chamber in a front-and-back direction toward upside in a manner so as to traverse the non-expanding portion. Therefore, since the lower expanding chamber is supported by the vertical expanding chamber from above, the lower expanding chamber is prevented or suppressed from being bent upward by tension force from the non-expanding portion.

In the curtain airbag according to the present invention, since the vertical expanding chamber is connected only to the lower expanding chamber allowing gas to flow therethrough, in the case when the gas is supplied into the curtain airbag, the gas flows into the vertical expanding chamber from the front expanding chamber and the rear expanding chamber, respectively, through the lower expanding chamber, after flowing into the front expanding chamber and the rear expanding chamber. Namely, in the present invention, since the gas supplied into the curtain airbag flows into the front expanding chamber and the rear expanding chamber first, the front expanding chamber and the rear expanding chamber are rapidly expanded even when a high-power gas generator is not used.

In the present invention, preferably, the distance between an upper end of the vertical expanding chamber and an upper expanding chamber disposed at an upper side of the non-expanding chamber is 30 mm or less. By thus constructing, since the expanded vertical expanding chamber does not practically or completely move upward, the expanded vertical expanding chamber is highly effective for preventing the lower expanding chamber from being bent.

### BRIEF DESCRIPTION OF THE DRAWINGS

FIG. 1 is a plan view illustrating a curtain airbag according to an embodiment.

FIG. 2 is a cross-sectional view taken along a line 2-2 in FIG. 1.

FIG. 3 is a cross-sectional view taken along a line 3-3 in FIG. 1.

### DETAILED DESCRIPTION OF THE PREFERRED EMBODIMENTS

Hereinbelow, an embodiment of the present invention will be explained with reference to the drawings.

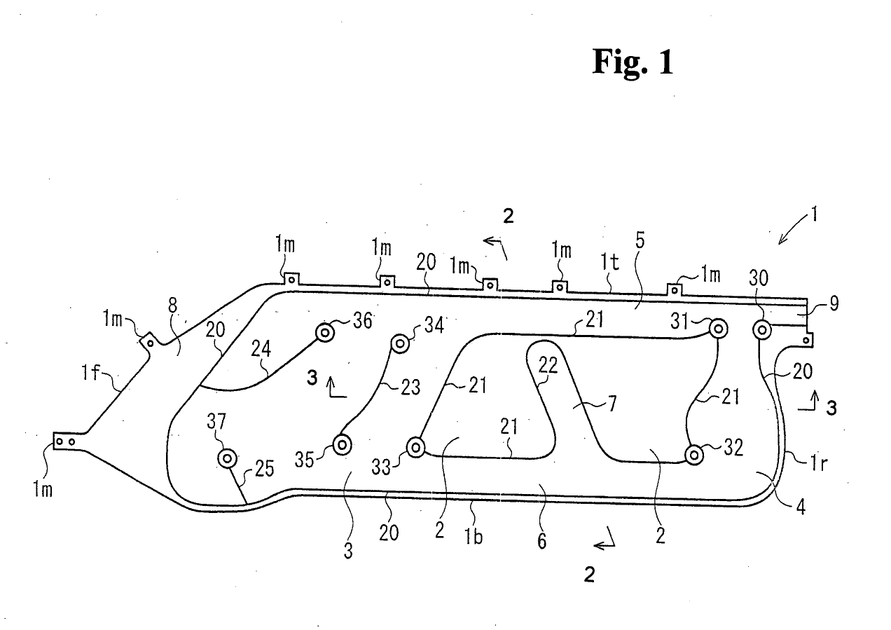

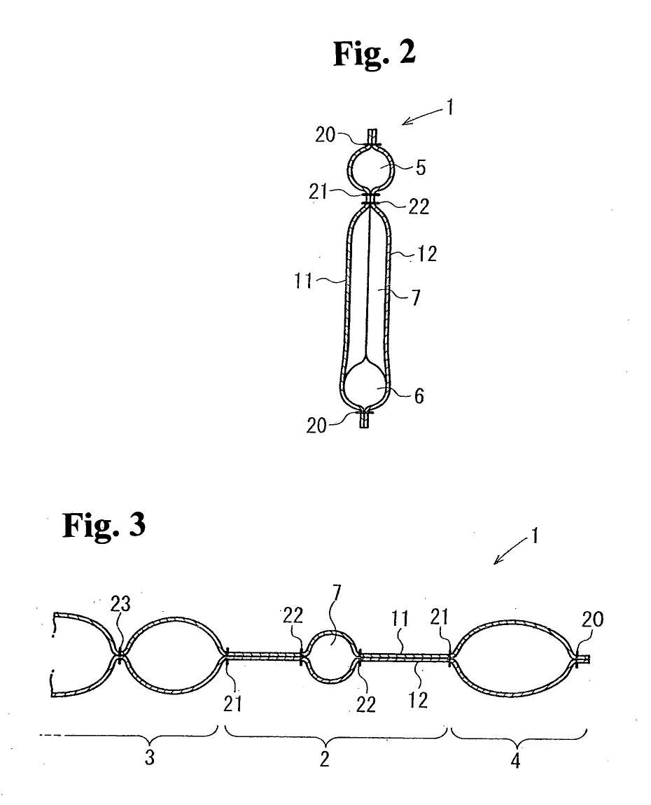

FIG. 1 is a plan view illustrating a curtain airbag 1 according to an embodiment of the present invention, FIG. 2 and FIG. 3 are cross-sections taken along a line 2-2 and a line 3-3 in FIG. 1, respectively.

Incidentally, in the explanation below, a front-and-back direction and a vertical direction are respectively conformed to the front-and-back direction of a vehicle and the vertical direction of the vehicle when the curtain airbag 1 is installed to the vehicle.

As illustrated in FIG. 1, in this embodiment, a non-expanding portion 2 is formed from the vicinity of a middle portion in the front-and-back direction of the curtain airbag 1 to a back end 1r side of the curtain airbag 1 over a predetermined width.

A front expanding chamber 3 is provided at a position situated closer to the front end if side of the curtain airbag 1 in relation to the non-expanding portion 2, and a rear expanding chamber 4 is provided at a position situated closer to the back end 1r side of the curtain airbag 1 in relation to the non-expanding portion 2.

Furthermore, an upper expanding chamber 5 extending in a substantially front-and-back direction along an upper edge 1t of the curtain airbag 1 is provided at an upper side of the non-expanding portion 2. A lower expanding chamber 6 extending in the substantially front-and-back direction along a lower edge 1b of the curtain airbag 1 is provided at a lower side of the non-expanding portion 2. As for the upper expanding chamber 5, a front end thereof is connected to an upper portion of the front expanding chamber 3 allowing gas to flow therethrough, and a back end thereof is connected to an upper portion of the rear expanding chamber 4 allowing the gas to flow therethrough. As for the lower expanding chamber 6, a front end thereof is connected to a lower portion of the front expanding chamber 3 allowing the gas to flow therethrough, and a back end thereof is connected to a lower portion of the rear expanding chamber 4 allowing the gas to flow therethrough.

A vertical expanding chamber 7 is extended substantially upward from a halfway portion of the lower expanding chamber 6 in a front-and-back direction thereof. In this embodiment, the vertical expanding chamber 7 is a rod-shaped thin long chamber, and is extending in a slanted vertical direction such that as the position on the vertical expanding chamber 7 is situated close the upper end side, the position on the vertical expanding chamber 7 is situated forward, as illustrated in FIG. 1. A lower end of the vertical expanding chamber 7 is connected to a halfway portion of the lower expanding chamber 6 in a front-and-back direction allowing the gas to flow therethrough. Moreover, the upper end of the vertical expanding chamber 7 faces a halfway portion of the upper expanding chamber 5 in a front-and-back direction.

The vertical expanding chamber 7 is connected only to the lower expanding chamber 6 allowing the gas to flow therethrough. Namely, in this embodiment, the upper end of the vertical expanding chamber 7 is spaced apart from the upper expanding chamber 5 as illustrated in FIG. 2, and the upper end of the vertical expanding chamber 7 is not directly connected to the upper expanding chamber 5 allowing the gas to flow therethrough. Further, the vertical expanding chamber 7 is spaced apart from the front expanding chamber 3 and the rear expanding chamber 4, respectively, as illustrated in FIG. 3, and the vertical expanding chamber 7 is not directly connected to the front expanding chamber 3 and the rear expanding chamber 4, respectively, allowing the gas to flow therethrough.

In the present invention, preferably, an interval between the upper end of the vertical expanding chamber 7 and the upper expanding chamber 5 is 30 mm or less.

Incidentally, in this embodiment, a non-expanding portion 8 also exists between the front expanding chamber 3 and the front end if of the curtain airbag 1 over a predetermined width.

In this embodiment, a gas-introducing inlet 9 is provided at a back end portion of the upper edge it of the curtain airbag 1. The gas-introducing inlet 9 faces an interflowing portion of the upper expanding chamber 5 and the rear expanding chamber 4.

A plurality of ear-shaped attaching pieces 1m is projected at intervals from the upper edge it and the front end if of the curtain airbag 1.

In this embodiment, in the curtain airbag 1, the expanding chambers 3 through 7, and the non-expanding portions 2 and 8 are formed between both an interior-side sheet 11 (in FIGS. 2 and 3) and an exterior-side sheet 12 (in FIGS. 2 and 3) by overlapping the interior-side sheet 11 and the exterior-side sheet 12 and combining each of the sheets 11 and 12 with linear connecting portions 20 through 25 and circular connecting portions 30 through 37.

Each of the linear connecting portions 20 through 25 and each of the circular connecting portions 30 through 37 are formed from a strong connecting device by which the sheets 11 and 12 are airtightly connected with each other and even when the internal pressure of the curtain airbag 1 is raised up to a designed upper limit pressure, the sheets 11 and 12 are not separated from each other (for example, a stitching work using a thread of high strength, an adhesive bonding using an adhesive agent of high adhesion force, or a welding).

The linear connecting portion 20 is extending in a manner such that the same is substantially revolving the curtain airbag 1. The linear connecting portion 20 is disconnected at the backend portion of the upper edge it of the curtain airbag 1, and thereby the gas-introducing inlet 9 is formed.

The linear connecting portion 20 is spaced apart from the front end if at the front end if side of the curtain airbag 1, and a portion between the linear connecting portion 20 and the front end if of the curtain airbag 1 serves as the non-expanding portion 8.

A linear connecting portion 21 is extending in an almost rectangularly revolving manner over a predetermined width from the vicinity of a center of the curtain airbag 1 to the back end 1r side of the curtain airbag 1.

An upper side and a lower side of the linear connecting portion 21 are respectively spaced apart from the linear connecting portion 20 along the upper edge it and the lower edge 1b of the curtain airbag 1. The upper expanding chamber 5 and the lower expanding chamber 6 are respectively formed between the linear connecting portion 20 along the upper edge 1t and the lower edge 1b of the curtain airbag 1 and the upper side and the lower side of the linear connecting portion 21.

A portion between a front side of the linear connecting portion 21 and the linear connecting portion 20, surrounding the front end 1f side of the curtain airbag 1, serves as the front expanding chamber 3. A portion between a back side of the linear connecting portion 21 and the linear connecting portion 20, surrounding the back end 1r side of the curtain airbag 1, serves as the rear expanding chamber 4.

The linear connecting portion 21 is disconnected at a halfway portion of the lower side in the extending direction, and an inverse U-shaped linear connecting portion 22 is extending from the disconnected portion toward an upper front side on a slant. Both ends of the linear connecting portion 22 are respectively connected to both ends of the linear connecting portion 21 facing the disconnected portion. Moreover, an upper end of the linear connecting portion 22 is spaced apart from an upper side of the linear connecting portion 21. An inside of the linear connecting portion 22 serves as the vertical expanding chamber 7.

An area surrounded by the linear connecting portions 21 and 22 is blocked from the gas-introducing inlet 9. Namely, the area surrounded by the linear connecting portions 21 and 22 serves as the non-expanding portion 2.

Linear connecting portions 23, 24, and 25 are portions where the sheets 11 and 12 are partially combined with each other at an inside or the front side expanding portion 3, respectively.

The linear connecting portion 23 is extending substantially in the vertical direction at a backside of the front expanding chamber 3 in a manner so as to follow a front side of the linear connecting portion 21. An upper end and a lower end of the linear connecting portion 23 are respectively spaced apart from the linear connecting portion 20, which is located along the upper edge 1t and the lower edge 1b of the curtain airbag 1.

The linear connecting portion 24 is extending substantially in the vertical direction in a manner so as to follow a front edge of the front side expanding portion 3. A lower end of the linear connecting portion 24 joins together with the linear connecting portion 20 in a manner so as to follow the front edge of the front side expanding portion 3. Further, an upper end of the linear connecting portion 24 is spaced apart from the linear connecting portion 20, which is located along the upper edge 1t of the curtain airbag 1.

The linear connecting portion 25 is extending toward an upper front side on a slant from a lower edge of the front expanding chamber 3. A lower end of the linear connecting portion 25 joins together with the linear connecting portion 20, which is located along the lower edge 1r of the curtain airbag 1, and an upper end of the linear connecting portion 25 is spaced apart from both of the linear connecting portions 20 and 23.

The circular connecting portion 30 reinforces the linear connecting portion 20 in the vicinity of a joining portion of the gas-introducing inlet 9 and the rear expanding chamber 4. The circular connecting portion 31 reinforces the linear connecting portion 21 in the vicinity of a joining portion of the rear expanding chamber 4 and the upper expanding chamber 5. The circular connecting portion 32 reinforces the linear connecting portion 21 in the vicinity of a joining portion of the rear expanding chamber 4 and the lower expanding chamber 6. The circular connecting portion 33 reinforces the linear connecting portion 21 in the vicinity of a joining portion of the front expanding chamber 3 and the lower expanding chamber 6.

The circular connecting portions 34 and 35 reinforce an upper end side and a lower end side of the linear connecting portion 23. The circular connecting portion 36 reinforces an upper end side of the linear connecting portion 24. The circular connecting portion 37 reinforces an upper end side of the linear connecting portion 25.

Although illustration is omitted, the curtain airbag 1 is disposed along a roof side portion (a border portion of a ceiling surface and a side surface of a vehicle interior) of an automobile in a thin and longly folded back condition in a front-and-back direction. Further, each of the attaching pieces 1m projected from the upper edge it and the front end 1f of the curtain airbag 1 are fixed to the roof side portion with a fixing attachment such as a bolt, a rivet, and so forth. An inflator (gas generator) is inserted into the gas-introducing inlet 9 at a back end side of the curtain airbag 1, and a fastening attachment such as a band or the like is tightened around an outer periphery of the gas-introducing inlet 9. Therefore, the inflator is attached. The inflator is fixed to a C-pillar or the like of the automobile. A folded back body of the curtain airbag 1 is covered with a roof garnish.

When an automobile provided with the thus constructed curtain airbag apparatus encounters a side collision or is overturned, the inflator is operated, the gas is supplied from the inflator into the curtain airbag 1, and the curtain airbag 1 starts to be expanded. The curtain airbag 1 is extended downward along a side surface of the vehicle interior while pushing open the roof garnish.

Currently, the gas supplied from the gas-introducing inlet 9 into the curtain airbag 1 flows into the rear expanding chamber 4 and the upper expanding chamber 5 first. The gas that flows into the upper expanding chamber 5 flows into the front expanding chamber 3 while passing through the upper expanding chamber 5. Then, the gas respectively flows from the front expanding chamber 3 and the rear expanding chamber 4 into the lower expanding chamber 6, and the gas flows into the vertical expanding chamber 7 through the lower expanding chamber 6.

Thus, in the curtain airbag 1, the gas supplied into the curtain airbag 1 flows into the front expanding chamber 3 and the rear expanding chamber 4 first. This is because the vertical expanding chamber 7 is only connected to the lower expanding chamber 6 allowing the gas to flow therethrough. Hence, even though a high-power inflator is not used, the front expanding chamber 3 and the rear expanding chamber 4 are rapidly expanded.

In the case when the curtain airbag 1 is expanded and extended, the vertical expanding chamber 7 is expanded substantially upward from the lower expanding chamber 6 in a manner so as to traverse the non-expanding portion 2. Therefore, the lower expanding chamber 6 comes to be supported from above by means of the vertical expanding chamber 7. Therefore, the lower expanding chamber 6 is prevented or suppressed from being bent upward by tension force applied from the non-expanding portion 2.

In this embodiment, since the interval between the upper end of the vertical expanding chamber 7 and the upper expanding chamber 5 is 30 mm or less, the expanded vertical expanding chamber 7 does not practically or completely move upward. Hence, the expanded vertical expanding chamber 7 is highly effective for preventing the lower expanding chamber 6 from being bent.

The aforementioned embodiment is illustrative of the present invention and is not to be construed as limiting the present invention.

For example, although the upper end of the vertical expanding chamber 7 is spaced apart from the upper expanding chamber 5 in the aforementioned embodiment, as long as the gas is blocked to flow therethrough between both, the upper end of the vertical expanding chamber 7 may be in contact with the lower edge of the upper expanding chamber 5.

Although one vertical expanding chamber is provided in the aforementioned embodiment, two or more vertical expanding chambers may be provided. In this case, vertical expanding chambers may be allowed to communicate with each other allowing the gas to flow therethrough.

Although the vertical expanding chamber is extending in a straight line in the aforementioned embodiment, at least partly, the vertical expanding chamber may have a curved shape or a bent shape. In the case that the vertical expanding chamber is provided two in number, two of both may extend parallel to each other or not parallel to each other. The vertical expanding chambers may intersect with each other. Intervals between each of the vertical expanding chambers and the upper expanding chamber may not have to be identical.

A construction of each of the chambers is not limited to the aforementioned embodiment. For example, the front expanding chamber and the rear expanding chamber may be partitioned into two or more chambers.

This application is based on, and claims priority of Japanese Patent Application No. 2007-039640, filed on Feb. 20, 2007, the contents of which are incorporated herein by reference.

While the invention has been explained with reference to the specific embodiments of the invention, the explanation is illustrative and the invention is limited only by the appended claims.

What is claimed is:

1. A curtain airbag, comprising:
a non-expanding portion located halfway along the curtain airbag in a front-and-back direction;
a front expanding chamber located at a vehicle front side of the non-expanding portion;
a rear expanding chamber located at a vehicle back side of the non-expanding portion;
an upper expanding chamber located at an upper side of the non-expanding portion;
a lower expanding chamber located at a lower side of the non-expanding portion; and
a vertical expanding chamber connected to the lower expanding chamber extending in the front-and-back direction, and extending upwardly therefrom, the vertical expanding chamber being connected only to the lower expanding chamber to allow the gas to flow therethrough.

2. A curtain airbag according to claim 1, wherein said curtain airbag extends downwardly along a side surface of a vehicle interior.

3. A curtain airbag according to claim 1, wherein said upper expanding chamber and the lower expanding chamber are respectively connected at the front expanding chamber and the rear expanding chamber allowing gas to flow therethrough.

4. A curtain airbag according to claim 3, wherein a distance between an upper end of the vertical expanding chamber and the upper expanding chamber is 30 mm or less.

5. A curtain airbag according to claim 3, wherein said vertical extending chamber is located substantially in a middle of the non-extending portion.

6. A curtain airbag according to claim 5, wherein said vertical extending chamber is inclined toward the front expanding chamber.

7. A curtain airbag according to claim 3, wherein said front expanding chamber includes at least one linear connecting portion for partly dividing the front expanding chamber therein.

8. A curtain airbag apparatus, comprising:
the curtain airbag according to claim 3, and
a gas generator for expanding the curtain airbag by supplying gas into the curtain airbag.
